(19) United States
(12) Patent Application Publication
(10) Pub. No.: US 2025/0026919 A1
(43) Pub. Date: Jan. 23, 2025

(54) CHEMICALLY MODIFIED MULTIFUNCTIONAL INORGANIC PARTICLES

(71) Applicant: The State of Israel, Ministry of Agriculture & Rural Development, Agricultural Research Organization, Rishon Lezion (IL)

(72) Inventors: Guy MECHREZ, Adi (IL); Karthik ANANTH MANI, Rishon Lezion (IL); Noga YAAKOV, Ramla (IL)

(21) Appl. No.: 18/707,095

(22) PCT Filed: Nov. 3, 2022
(86) PCT No.: PCT/IL2022/051165

§ 371 Date: May 2, 2024

Related U.S. Application Data
(60) Provisional application No. 63/329,516, filed on Apr. 11, 2022.
(60) Provisional application No. 63/275,567, filed on Nov. 4, 2021.

(51) Int. Cl. C08K 9/06; B65D 65/40; C08J 3/20; C08L 23/06; C09C 1/30

(52) U.S. Cl. CPC C08K 9/06; C08J 3/201; C08L 23/06; C09C 1/3081; B65D 65/40; B65D 2565/385; C01P 2004/64; C08J 2323/06; C08J 2421/00; C08J 2423/06; C08J 2423/12; C08K 2201/011; C08L 2203/30; C08L 2205/025; C08L 2205/08

(57) ABSTRACT

A composition comprising modified multifunctional inorganic particles is provided. An article or composite comprising a thermoplastic polymer or a plurality of immiscible polymers and the modified particles homogenously distributed therewithin is provided. Further, a method for preparing the composites is provided.

### CROSS-REFERENCE TO RELATED APPLICATIONS

This application claims the benefit of priority of U.S. Provisional Application No. 63/275,567, filed 4 Nov. 2021 and U.S. Provisional Application No. 63/329,516, filed 11 Apr. 2022, both titled “CHEMICALLY MODIFIED MULTIFUNCTIONAL INORGANIC PARTICLES”, the contents of which are incorporated herein by reference in their entirety.

### FIELD OF THE INVENTION

The present invention is in the field of modified inorganic particles and uses thereof such as for compatibilization of immiscible polymers.

### BACKGROUND OF THE INVENTION

Modern plastic packaging materials often contain multilayer laminated films. Most of these laminates have two or more polymeric films, composed of immiscible polymers. In most cases the outer layer of the laminate is composed of polyethylene terephthalate (PET) or polypropylene (PP) and is used mostly to provide heat resistance, printability, and/or clarity thereto. The inner film of the laminate is usually composed of polyethylene (PE) and is used mostly for providing a moisture barrier, and in most cases, is 3-10 times thicker than the outer layer. Furthermore, such laminates have additional polymeric layers such as ethylene vinyl alcohol (EVOH) film, to provide gas barrier properties, or aluminum foil and others.

To this end, such multilayer laminated films cannot be recycled due to the fact that they are made of chemically distinct immiscible polymers. Since the distinct polymeric layers cannot be separated, the entire laminate cannot be recycled and it is either dumped or burnt, causing significant environmental damage. The industry is avoiding recycling packages made of multiple different resins.

Introducing a compatibilizer that stabilizes a multi-component polymer blend may be a practical solution to improve the performance of immiscible polymer blends and potentially turn plastic waste into a valuable product again.

Accordingly, there is a need for new compatibilizers which can contribute to the recyclability of the multilayer laminated films.

### SUMMARY OF THE INVENTION

In one aspect of the invention, there is provided a modified particle comprising an inorganic nanoparticle covalently bound to a first moiety and to a second moiety, wherein: the first moiety is selected from the group comprising an alkyl, and alkenyl or both; and the second moiety is selected from the group comprising aromatic ester, haloalkyl, mercaptoalkyl, alkyl ester, disulphide, trisulphide, tetrasulphide, mercapto, propylene oxide, or any combination thereof.

In one embodiment, a molar ratio between the first moiety and the second moiety within the modified particle is between 2:1 and 1:2.

In one embodiment, an outer surface of the inorganic nanoparticle is covalently bound to the first moiety, and to the second moiety via a siloxy bond.

In one embodiment, the first moiety comprises an C8-C20 alkyl.

In one embodiment, the first moiety comprises a C10-C15 alkyl.

In one embodiment, the second moiety comprises any of a benzoyl ester, and a C8-C20 haloalkyl.

In one embodiment, the second moiety comprises any of benzoyloxy propyl, perfluorooctyltriethoxysilane (FAS), tricholoro (octadecyl) silane (OTS), or any combination thereof.

In one embodiment, the inorganic nanoparticle comprises a metal oxide, optionally wherein the inorganic nanoparticle comprises silica nanoparticle.

In one embodiment, the first moiety and the second moiety are assembled in a form of a shell; and wherein the first moiety and the second moiety are substantially uniformly distributed on the outer surface of the inorganic nanoparticle.

In one embodiment, the inorganic nanoparticle is characterized by an average particle size of between 1 and 100 nm.

In one embodiment, the particle is dispersible within a polymeric melt comprising at least two immiscible polymers.

In one embodiment, dispersible is up to 10% (w/w) of the particles within the polymeric melt.

In one embodiment, the polymeric melt comprises polyethylene (PE) and an additional polymer, wherein the additional polymer comprises a polyolefin (e.g., PP), a polyvinylchloride, polystyrene, rubber, a polyester (e.g., PET), polyurethane, or any combination thereof.

In another aspect, there is provided a solid composite comprising the particles of the invention distributed within a polymeric matrix, wherein the polymeric matrix is any one of: (i) a thermoplastic polymer or rubber; (ii) a plurality of immiscible polymers; and wherein a w/w concentration of the particles within the polymeric matrix is between 0.01 and 10%.

In one embodiment, the plurality of immiscible polymers comprises a first polymer, and a second polymer immiscible with the first polymer, and wherein the first polymer is polyethylene.

In one embodiment, a w/w ratio of the first polymer to the second polymer within the polymeric matrix is between 1:100 and 1:1, optionally between 1:20 and 1:3.

In one embodiment, the first polymer and the second polymer are homogenously distributed within the solid composite.

In one embodiment, the particle is substantially uniformly distributed within the polymeric matrix.

In one embodiment, the second polymer comprises a polyolefin which is not PE (e.g., polypropylene, poly(l-butene), poly(l-hexene), poly(l-octene), polyisobutylene), a polyvinylchloride, polystyrene, rubber, a polyester (e.g., PET), polyurethane, or any combination thereof.

In one embodiment, the solid composite is characterized by at least one improved mechanical property selected from: modulus, impact at notch, stress at brake, yield strain, tensile strength, elongation at break, impact resistance or any combination thereof.

In one embodiment, the solid composite is shapeable (e.g., extrudable or moldable).

In another aspect, there is provided a method for forming the solid composite of the invention, comprising: providing a first thermoplastic polymer and optionally a second thermoplastic polymer under conditions suitable for melting, to obtain a melt; mixing the melt with a sufficient amount of the particles of the invention, thereby forming a mixture; and providing the mixture under conditions suitable for solidifying of the mixture, thereby forming the solid composite.

In one embodiment, conditions suitable for melting comprise a temperature sufficient for melting of the first thermoplastic polymer and optionally of the second thermoplastic polymer.

In one embodiment, mixing comprises stirring, high shear mixing, ultrasonication, overhead stirring, homogenizing, or a combination thereof.

In one embodiment, the steps a. and b. are performed simultaneously, such as by extrusion.

In one embodiment, a w/w concentration of the particles within the melt is between 0.1 and 10%.

In one embodiment, a w/w ratio of the first polymer to the second polymer within the melt is between 1:100 and 1:1, optionally between 1:20 and 1:3.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

Further embodiments and the full scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### DETAILED DESCRIPTION OF THE INVENTION

In one aspect of the invention, disclosed herein are modified inorganic nanoparticles for compatibilization of polymer blends composed of immiscible thermoplastic polymers. In some embodiments, the modified inorganic nanoparticles are chemically modified multifunctional particles, with plurality of functional groups covalently bound to the particle's surface.

The modified inorganic nanoparticles are inter alia incorporated into the polymer matrix via compounding and can be utilized to stabilize different polymer blends including PE/PP, PE/PE, PVE/PE, PE/rubber, PP/rubber. Furthermore, the inorganic nanoparticles disclosed herein can be utilized for compatibilization between additives and polymers.

To this end, the modified inorganic nanoparticles of the present invention have been utilized for compatibilization of immiscible polymers, to obtain stable homogenous polymeric blends with enhanced properties.

Furthermore, the modified inorganic nanoparticles have been successfully utilized to generate high-performance materials from polymer blends, such as PE-PVC, PE-PET, PE/PP, PE/rubber and more.

According to some embodiments, the present invention provides a modified particle comprising a nanoparticle covalently bound to a plurality of first moieties and to a plurality of second moieties, wherein: each of the plurality of the first moieties comprises a residue selected from the group comprising an alkyl, and alkenyl or both; and each of the plurality of the second moiety comprises a residue selected from the group comprising aromatic ester, a benzoyl ester, an alkyl ester, aromatic thioester, alkyl thioester, haloalkyl, mercaptoalkyl, disulphide, trisulphide, tetrasulphide, mercapto, ether, thioether, amine, amide, amidine, guanidine, carbamate, sulfoxide, sulfone, propylene oxide, or any combination thereof. In some embodiments, the residue of the first moiety comprises a cyclic alkyl/alkenyl and/or a linear alkyl/alkenyl. In some embodiments, the second moiety comprises a residue selected from an aromatic ester, a benzoyl ester, an alkyl ester, an aromatic thioester, and an alkyl thioester.

In some embodiments, the plurality of first moieties comprises the same residues. In some embodiments, the plurality of first moieties comprises chemically distinct residues. In some embodiments, the plurality of second moieties comprises the same residues. In some embodiments, the plurality of second moieties comprises chemically distinct residues. In some embodiments, each of the plurality of first moieties has chemically identical or chemically distinct residues. In some embodiments, each of the plurality of second moieties has chemically identical or chemically distinct residues.

In some embodiments, at least a portion of the outer surface of the modified particle is chemically modified by the first moiety and the second moiety. In some embodiments, the residue of the first moiety and of the second moiety are bound to the nanoparticle via a functional group capable of reacting with the surface atom(s) of the nanoparticle. In some embodiments, the first moiety and the second moiety are bound to the nanoparticle via a functional group selected from silyl, siloxane, carboxy, ester, ether, carbonyl, phosphate, phosphine, alkyl, including any combination thereof.

In some embodiments, the first moiety and the second moiety are bound to the nanoparticle via —O—, a silicon atom or via a silyl bond (e.g. —Si(R)₂—), wherein each R is independently selected from hydrogen, optionally substituted alkyl, optionally substituted cycloalkyl, optionally substituted alkenyl, optionally substituted aryl, and halo; or via a siloxy bond (e.g., —O—Si(R1)₂—), wherein each R1 is independently selected from —O—, OH and alkoxy).

In some embodiments, the nanoparticle is or comprises an inorganic nanoparticle. In some embodiments, provided herein a composition comprising a plurality of inorganic nanoparticles. In some embodiments, the composition comprises chemically identical nanoparticles. In some embodiments, the composition comprises chemically distinct nanoparticles.

In some embodiments, the inorganic nanoparticle comprises a metal oxide particle. In some embodiments, the inorganic nanoparticle comprises a metalloid oxide particle. In some embodiments, the composition comprises a single metal oxide (or metalloid oxide) nanoparticle specie, or a plurality of distinct metal oxide or metalloid oxide species.

In some embodiments, the inorganic nanoparticle consists essentially of the metal oxide or metalloid oxide. In some embodiments, the inorganic nanoparticle is silica nanoparticle. Additional metal oxide or metalloid oxide nanoparticles are well-known in the art (e.g. titania, zirconia, ZnO-nanoparticles, etc.).

In some embodiments, the inorganic nanoparticle is a hydrophobic metalloid oxide or metal oxide nanoparticle.

In some embodiments, hydrophobic metalloid oxide or metalloid oxide nanoparticles are selected from halogenated (e.g., fluorinated) nanoparticles, haloalkylated (e.g., fluoroalkylated) nanoparticles, silylated nanoparticles, or any combination thereof.

Non-limiting examples of silylated nanoparticles include metal oxide or metalloid oxide nanoparticles modified with silyl, methyl silyl, dimethyl silyl, (C1-C4)alkylsilyl, (C1-C20 or C8-C20) linear alkyl silyl, (C1-C20 or C8-C20) branched alkyl silyl, aromatic silane, halosilyl, halo(C1-C20)alkylsilyl, haloalkylsilyl, esterified silyl, fluorinated (C1-C20 or C8-C20)alkyl silyl, and (C1-C20 or C8-C20)dialkyl silyl or a combination thereof.

As used herein, the term “C1-C4” refers to an optionally modified alkyl chain comprising 1, 2, 3, or 4 carbon atoms including any range between.

As used herein, the term “C1-C20” refers to an optionally modified alkyl chain comprising between 1 and 4, between 4 and 6, between 6 and 8, between 8 and 10, between 10 and 14, between 14 and 16, between 16 and 20 carbon atoms including any range between. As used herein, the term “C8-C20” refers to an optionally modified alkyl chain comprising between 8 and 20, between 8 and 15, between 8 and 12, between 8 and 10, between 10 and 14, between 14 and 16, between 16 and 20 carbon atoms including any range between.

As used herein, the term “alkyl” comprises an alkane, an alkene, or an alkyne.

The term “silica” as used herein refers to a structure containing at least the following the elements: silicon and oxygen. Silica may have the fundamental formula of SiO₂. or it may have another structure including SiₓO_{y} (where x and y can each independently be about 1 to 10). Additional elements including, but not limited to, carbon, nitrogen, sulfur, phosphorus, or ruthenium may also be used. Silica may be a solid substantially non-porous particle, or it may have pores (such as mesoporous silica).

In some embodiments, the inorganic nanoparticle is characterized by a porosity (e.g. BET surface area) of between 10 and 300 m2/g, between 50 and 300 m2/g, between 100 and 300 m2/g, between 100 and 200 m2/g, including any range between.

As used herein, the term “substituted” or the term “substituent” are related to one or more (e.g. 2, 3, 4, 5, or 6) substituents, wherein the substituent(s) is as described herein. In some embodiments, the term “substituted” or the term “substituent” comprises one or more substituents selected from (C₀-C₆)alkyl-aryl, (C₀-C₆)alkyl-heteroaryl, (C₀-C₆)alkyl-(C₃-C₈) cycloalkyl, optionally substituted C₃-C₈ heterocyclyl, halogen, NO₂, CN, OH, CONH₂, CONR₂, CNNR₂, CSNR₂, CONH—OH, CONH—NH₂, NHCOR, NHCSR, NHCNR, —NC(═O) OR, —NC(═O) NR, —NC(═S) OR, —NC(═S) NR, SO₂R, SOR, —SR, SO₂OR, SO₂N(R)₂, —NHNR₂, —NNR, C₁-C₆ haloalkyl, optionally substituted C₁-C₆ alkyl, NH₂, NH(C₁-C₆ alkyl), N(C₁-C₆ alkyl) 2, C₁-C₆ alkoxy, C₁-C₆ haloalkoxy, hydroxy (C₁-C₆ alkyl), hydroxy (C₁-C₆ alkoxy), alkoxy (C₁-C₆ alkyl), alkoxy (C₁-C₆ alkoxy), C₁-C₆ alkylNR₂, C₁-C₆ alkylSR, CONH(C₁-C₆ alkyl), CON(C₁-C₆ alkyl)₂, CO₂H, CO₂R, —OCOR, —OCOR, —OC(═O) OR, —OC(═O) NR, —OC(═S) OR, —OC(═S) NR, or a combination thereof, wherein each R is independently selected from hydrogen, alkyl, alkenyl, aryl, heteroaryl a heteroatom, an optionally substituted cycloalkyl, an optionally substituted heterocyclyl, or any combination thereof.

In some embodiments, the modified particle of the invention comprises a metalloid oxide nanoparticle (e.g. a particle composed essentially of SiO₂) covalently bound to the first moiety and to the second moiety via an oxygen atom. In some embodiments, the oxygen atom is a terminal oxygen atom located at the surface (or the outer portion) of the metal oxide particle. In some embodiments, the first moiety and the second moiety are covalently bound to the silica particle via a terminal oxygen atom. In some embodiments, the terminal oxygen atom refers to an oxygen atom bound to a single silicon atom (e.g. —Si—OH), wherein the terminal oxygen atom is underlined, wherein an outer surface of the inorganic nanoparticle is covalently bound to the residue of the first moiety, and to the second moiety via a siloxy bond. In some embodiments, the siloxy bond refers to —Si—O—R, wherein R represents the residue of the first moiety, and/or of the second moiety; and wherein—represent the attachment point to the silica particle or to the silicon dioxide chain of the silica particle.

In some embodiments, the first moiety and the second moiety is independently represented by Formula:—XR, wherein X represents the functional group of the first moiety or of the second moiety, as described herein (e.g. silyl, siloxane, carboxy, phosphate, etc.); and wherein R represents the residue of the first moiety or of the second moiety, as described herein.

In some embodiments, the first moiety and the second moiety is independently represented by Formula: —SiR(R₁)₂, wherein-represents the attachment point to the inorganic particle, wherein R represents the residue of the first moiety or of the second moiety, as described herein; and wherein each R₁ is independently selected from O—, OH, OR′, and H, or R₁ represents a bond to the inorganic nanoparticle, or to an adjacent first moiety or to an adjacent second moiety.

In some embodiments, the first moiety comprises an R selected from (C1-C20)alkyl, (C8-C20)alkyl, a cycloalkane, (C1-C20)alkene, (C8-C20)alkene, (C1-C20)alkyne, (C8-C20)alkyne or any combination thereof. In some embodiments, the first moiety comprises an R comprising a C8-C20 alkyl, or a C10-C15 alkyl. In some embodiments, the first moiety is represented by Formula: SiR(R₁)₂, wherein Riis as described herein, and R is or comprises a C8-C20 alkyl, or a C10-C15 alkyl. In some embodiments, R₁ is OH. In some embodiments, R of the first moiety comprises C12 alkyl.

In some embodiments, the second moiety comprises an R selected from an aromatic ester, a benzoyl ester, haloalkyl, mercaptoalkyl, alkyl ester, alkyl thioester, alkyl disulphide, alkyl trisulphide, alkyl tetrasulphide, mercapto, propylene oxide (or propoxy), or any combination thereof.

In some embodiments, the second moiety comprises an R selected from an alkyl-aryl ester, alkyl-benzoyl ester, alkyl-thioester, and a C8-C20 haloalkyl. In some embodiments, the second moiety comprises an R of Formulae: X—C(═O)-Het-(C₁₋₁₀)—; X-Het-C(═O)— (C₁₋₁₀)—; —X—C(═O)-Het-(C₁₋₁₀)₁₋₂; C1-C10alkyl-C(═O)-Het-(C₁₋₁₀)—; —[CH₂]ₙ—O—C(═O)—X; — [CH₂]ₙ—C(═O)—O—X; or —[CH₂]ₙ—S—C(═O)—[CH₂]ₙ, wherein n is between 1 and 20; wherein Het represents a heteroatom selected from —O—, —S—, —N—, and —NH—; and wherein X represents an aryl or a heteroaryl optionally substituted by one or more substituent selected from mercapto, cyano, amino, hydroxy, alkoxy, haloalkyl, alkyl, carboxy, mercaptoalkyl, halo, or any combination thereof.

In some embodiments, R of the second moiety comprises benzoyloxy propyl, perfluorooctanoyl, octadecanoyl, and S-(Octanoyl) mercaptopropyl or any combination thereof. In some embodiments, R of the second moiety comprises benzoyloxy propyl and/or S-(Octanoyl) mercaptopropyl.

In some embodiments, the inorganic nanoparticle of the invention is or comprises a fumed silica. Additional silica nanoparticles are well-known in the art.

In some embodiments, the modified particles of the invention are characterized by an average particle size of between 1 nm and 900 nm. In some embodiments, the modified particles within the composition of the invention are characterized by an average particle size of between 2 nm to 600 nm, 2 nm to 550 nm, 2 nm to 520 nm, 2 nm to 500 nm, 2 nm to 480 nm, 2 nm to 450 nm, 2 nm to 400 nm, 2 nm to 350 nm, 2 nm to 300 nm, 2 nm to 250 nm, 2 nm to 200 nm, 2 nm to 150 nm, 2 nm to 100 nm, 5 nm to 600 nm, 10 nm to 600 nm, 15 nm to 600 nm, 20 nm to 600 nm, 40 nm to 600 nm, 50 nm to 600 nm, 100 nm to 600 nm, 5 nm to 500 nm, 10 nm to 500 nm, 15 nm to 500 nm, 20 nm to 500 nm, 40 nm to 600 nm, 50 nm to 500 nm, 100 nm to 500 nm, 5 nm to 400 nm, 10 nm to 400 nm, 15 nm to 400 nm, 20 nm to 400 nm, 40 nm to 400 nm, 50 nm to 400 nm, 100 nm to 400 nm, 5 nm to 50 nm, 5 nm to 40 nm, 2 nm to 50 nm, between 1 and 10, between 1 and 50, between 10 and 30, between 30 and 50, between 50 and 70, between 70 and 100, or 2 nm to 40 nm, including any range therebetween. In some embodiments, the modified particles within the composition of the invention are characterized by an average particle size of between 10 and 50 nm, or between 10 and 100 nm. In some embodiments, the size of at least 90% of the metal oxide nanoparticles varies within a range of less than ±25%, ±20%, ±15%, ±19%, ±5%, including any value therebetween.

In some embodiments, the terms “nanoparticle”, “nano”, “nanosized”, and any grammatical derivative thereof, which are used herein interchangeably, describe a particle featuring a size of at least one dimension thereof (e.g., diameter, length) that ranges from about 1 nanometer to 100 nanometers. Herein throughout, “NP(s)” designates nanoparticle(s).

As used herein the terms “average” or “median” size refer to an average diameter of the primary particles, as opposed to particle agglomerates or aggregates. The term “diameter” is art-recognized and is used herein to refer to either of the physical diameter (also termed “dry diameter”) or the hydrodynamic diameter. As used herein, the “hydrodynamic diameter” refers to a size determination for the composition in solution (e.g., aqueous solution) using any technique known in the art, e.g., dynamic light scattering (DLS).

In some embodiments, the weight portion of the first moiety and of the second moiety within the modified particle of the comprises 0.01% to 10% (w/w), 0.05% to 10% (w/w), 0.09% to 10% (w/w), 0.1% to 10% (w/w), 0.5% to 10% (w/w), 0.9% to 10% (w/w), 1% to 10% (w/w), 10% to 15% (w/w), 15% to 20% (w/w), 5% to 10% (w/w), 0.01% to 9% (w/w), 0.05% to 9% (w/w), 0.09% to 9% (w/w), 0.1% to 9% (w/w), 0.5% to 9% (w/w), 0.9% to 9% (w/w), 1% to 3% (w/w), 3% to 5% (w/w), 5% to 9% (w/w), 5% to 7% (w/w), 7% to 10% (w/w), 1% to 9% (w/w), 5% to 9% (w/w), 0.01% to 5% (w/w), 0.05% to 5% (w/w), 0.09% to 5% (w/w), 0.1% to 5% (w/w), 0.5% to 5% (w/w), 0.9% to 5% (w/w), or 1% to 5% (w/w), including any range therebetween.

In some embodiments, a molar ratio between the first moiety and the second moiety within the modified particle is between 5:1 and 1:5, between 2:1 and 1:2, between 2:1 and 1.5:1, between 1.5:1 and 1:1, between 1:1 and 1:1.5, between 1:1.5 and 1:2,), including any range therebetween.

In some embodiments, the first moiety and the second moiety are substantially uniformly distributed within the surface of the modified particle. In some embodiments, the first moiety and the second moiety are homogenously mixed within the surface. In some embodiments, the first moiety and the second moiety are assembled in a form of a shell on top of the modified particle. In some embodiments, the modified particle is a core-shell particle, wherein the shell faces an ambient and is covalently bound to the core. In some embodiments, the core comprises the metal oxide particle. In some embodiments, the core consists essentially of the metal oxide. In some embodiments, the shell consists essentially of the first moiety and the second moiety. In some embodiments, the shell is substantially devoid of one or more regions consists essentially of the first moiety or of the second moiety. In some embodiments, the modified particle is substantially devoid of a dual-mode particle (e.g., a Janus particle).

In some embodiments, the modified particle comprises a metalloid oxide (e.g., silica) nanoparticle core, and the shell comprising the first moiety and the second moiety, as described herein, wherein the first moiety and the second moiety are substantially uniformly distributed within the entire shell volume.

In some embodiments, the modified particle of the invention is compatible with any one of a first polymer, a second polymer or both, wherein the first polymer and the second polymer are immiscible or incompatible polymers. In some embodiments, the modified particle of the invention is compatible within a polymer blend comprising a plurality of immiscible polymers.

In some embodiments, the term “compatible” refers to the ability of the modified particle of the invention to form a stable dispersion within the first polymer, the second polymer or a blend thereof, wherein the polymer(s) are in a molten state. In some embodiments, the term “compatible” refers to dispersibility of the modified particle of the invention within a polymeric melt comprising the first and/or the second polymer, as described herein. In some embodiments, the compatible particle of the invention forms a stable composite, wherein stable refers to the stability of the solid composite, e.g., upon cooling thereof to a temperature below the melting point of the polymer. In some embodiments, a stable solid composite is as described herein.

In some embodiments, the modified particle of the invention has an affinity to the first and/or the second polymer (e.g., in a molten state or within a solution).

In some embodiments, the first polymer and the second polymer are thermoplastic polymers. In some embodiments, the first polymer is or comprises polyethylene (PE) and the second polymer comprises any of a polyolefin (e.g. a polyolefin which is not PE, such as PP, poly(l-butene), poly(l-hexene), poly(l-octene), polyisobutylene), a halogenated polyolefin (e.g. polyvinylchloride), ethylene vinyl alcohol (EVOH) polystyrene, rubber (e.g. polyisoprene, and/or a vulcanized rubber), a polyester (e.g. PET), polyurethane, including any copolymer, or any combination thereof.

In some embodiments, the term “rubber” encompasses a vulcanized and a non-vulcanized rubber. Exemplary rubbers (vulcanized or non-vulcanized) include but are not limited to polyisoprene, polybutadiene, styrene-butadiene, and ethylene propylene diene monomer rubber (EPDM rubber). In some embodiments, the term “rubber” encompasses a thermoplastic or a thermoset polymer.

In some embodiments, the first polymer and the second polymer are thermoplastic. In some embodiments, the second polymer is thermoset.

In one embodiment, polyethylene comprises low-density polyethylene (LDPE), linear low-density polyethylene (LLDPE), very-low-density polyethylene (VLDPE), ultra-low-density polyethylene (ULDPE), medium-density polyethylene (MDPE), high-density polyethylene (HDPE) including any copolymer or any combination thereof.

In some embodiments, the first polymer and the second polymer have substantially the same melting point (e.g., melting point deviation in a range of up to 30%, up to 20%, up to 10%, up to 5%, or less, including any range between).

In some embodiments, the modified particle of the invention is dispersible within the first polymer, the second polymer, or within a polymer blend (in a molten state), as described herein, wherein dispersible is at most 10%, at most 8%, at most 5%, at most 3%, at most 1% w/w of the modified particle relative to the total weight of the dispersion, including any range between. In some embodiments, the modified particle of the invention is dispersible within a melt comprising the first polymer in a molten state, and the second polymer. In some embodiments, the modified particle of the invention is dispersible within a melt comprising the first polymer in a molten state, and the second polymer (at least partially in a molten state). In some embodiments, the melt is homogenous, wherein the first and the second polymer are homogenously mixed. In some embodiments, a w/w ratio between the first polymer and the second polymer within the melt is between 1:100 and 100:1, including any range between. In some embodiments, a w/w ratio between the first polymer and the second polymer within the melt is between 1:1 and 1:100, between 1:1 and 1:50, between 1:1 and 1:80, between 1:1 and 1:30, between 1:10 and 1:50, including any range between.

In some embodiments, the modified particle of the invention is dispersible within a solution comprising the first polymer, the second polymer, or a mixture thereof.

In some embodiments, the composition of the invention comprises the modified particles and further comprises an organic solvent.

### Composite

In another aspect, there is provided a solid composite comprising the modified particle of the invention distributed within a polymeric matrix, wherein the polymeric matrix comprises at least one first polymer and at least one second polymer; wherein the first polymer and the second polymer are immiscible polymers. In some embodiments, the first polymer and the second polymer are as described hereinabove.

In another aspect, there is provided a solid composite comprising the modified particle of the invention distributed within a polymeric matrix, wherein the polymeric matrix comprises at least one first polymer and at least one second polymer; and wherein a w/w concentration of the modified particle within the polymeric matrix is between 0.01 and 10%.

In some embodiments, the polymeric matrix is any one of: a thermoplastic polymer, a plurality of immiscible polymers. In some embodiments, the polymeric matrix is or comprises the first polymer, the second polymer, or both (e.g., a polymer blend comprising a plurality of immiscible polymers), wherein the first polymer and the second polymer are as described herein.

In some embodiments, the composite comprises a sufficient amount of the modified particles. In some embodiments, a w/w concentration of the modified particle within composite is sufficient for stabilizing the composite (e.g., preventing separation, or any other mechanical defects). In some embodiments, the sufficient amount is predetermined by the chemical composition of the blend, and/or by the desired mechanical properties of the resulting composite. In some embodiments, the mechanical properties of the composite are variable by modifying the w/w concentration of the modified particle within the composite.

In some embodiments, a w/w concentration of the modified particle within the polymeric matrix is between 0.01 and 10%, between 0.01% to 10% (w/w), 0.05% to 10% (w/w), 0.09% to 10% (w/w), 0.1% to 10% (w/w), 0.5% to 10% (w/w), 0.9% to 10% (w/w), 1% to 10% (w/w), 10% to 15% (w/w), 15% to 20% (w/w), 5% to 10% (w/w), 0.01% to 9% (w/w), 0.05% to 9% (w/w), 0.09% to 9% (w/w), 0.1% to 9% (w/w), 0.5% to 9% (w/w), 0.9% to 9% (w/w), 1% to 3% (w/w), 3% to 5% (w/w), 5% to 9% (w/w), 5% to 7% (w/w), 7% to 10% (w/w), 1% to 9% (w/w), 5% to 9% (w/w), 0.01% to 5% (w/w), 0.05% to 5% (w/w), 0.09% to 5% (w/w), 0.1% to 5% (w/w), 0.5% to 5% (w/w), 0.9% to 5% (w/w), or 1% to 5% (w/w), including any range therebetween.

In some embodiments, the solid composite of the invention is chemically stable (e.g., maintains at least 90% of its chemical composition) at a temperature of about 100° C., of about 80° C., of about 90° C., of about 70° C., of about 60° C., of about 50° C., of about 40° C. or less, including any range or value therebetween. In some embodiments, the solid composite of the invention refers to as “stable” when it maintains at least 90% of its physical properties at a temperature of about 100° C., of about 80° C., of about 90° C., of about 70° C., of about 60° C., of about 50° C., of about 40° C. or less, including any range or value therebetween.

In some embodiments, the solid composite of the invention is stable for a time period of at least 1 day, at least 1 week, at least 1 month, at least 1 year, at least 10 years, including any range between upon storage at normal storage conditions. In some embodiments, a stable solid composite substantially maintains it's physical intactness and/or composition (and optionally is substantially devoid of structural defects, such as separations, cracks etc.) under normal storage conditions over a time period ranging from 1 day to 1 month (m), from 1 m to 2 m, from 2 m to 4 m, from 4 m to 6 m, from 6 m to 8 m, from 8 m to 10 m, from 10 m to 12 m, from 1 to 10 years, including any range between.

In some embodiments, normal storage conditions refer to a temperature of between-40 and 100° C., between-40 and 80° C., between-40 and 60° C. including any range or value therebetween; and to an ambient atmosphere (atmospheric gases, normal pressure, humidity, etc.). In some embodiments, the solid composite remains substantially intact for a time period described herein, wherein the solid composite is exposed to operable conditions (such as temperature, pressure, etc., sufficient for processing or shaping of the composite such as via extrusion).

In some embodiments, a w/w ratio between the first polymer and the second polymer within the polymeric matrix (or within the solid composite of the invention) is between 1:100 and 1:1, between 1:1 and 1:10, between 1:10 and 1:20, between 1:2 and 1:20, between 1:3 and 1:20, between 1:20 and 1:30, between 1:30 and 1:50, between 1:50 and 1:100, including any range or value therebetween.

In some embodiments, the polymeric matrix comprises the first polymer and the second polymer homogenously mixed or distributed therewithin. In some embodiments, the modified particle is substantially uniformly distributed within the polymeric matrix. In some embodiments, the modified particle is substantially uniformly distributed within the entire volume of the polymeric matrix. In some embodiments, the composite of the invention comprises the modified particle, the first polymer and the second polymer homogenously mixed or distributed within the composite.

In some embodiments, the composite comprises a bi-phasic (or multi-phasic) mixture, wherein the modified particles are located at the interphase between the phases. In some embodiments, each phase independently comprises the first polymer or the second polymer.

In some embodiments, the composite is thermoplastic. In some embodiments, the composite is an extrudate. In some embodiments, the composite is compatible with an extruder. In some embodiments, the composite of the invention is extrudable. In some embodiments, the composite is flowable in a molten state. In some embodiments, the melt flow index (MFI) of the composite of the invention is predetermined by the w/w ratio between the first and the second polymer, and optionally by the w/w concentration of the modified particle of the invention.

In some embodiments, the composite of the invention is manufactured and/or processed via an extrusion process.

In some embodiments, the composite of the invention is characterized by MFI of between 0.1 and 100, between 0.1 and 1, between 1 and 10, between 10 and 50, between 50 and 100, including any range between.

In some embodiments, the composite of the invention is shapeable. In some embodiments, the composite of the invention is shapeable via a hot melt processing. In some embodiments, the composite of the invention is shapeable or formable (e.g., capable of obtaining a predetermined shape) via a hot melt process selected from extrusion, injection, hot blown film, heat molding (e.g., cast molding, compression molding, rotational molding) or any combination thereof.

In some embodiments, the composite of the invention further comprises an additive. In some embodiments, the additive comprises a polymer. In some embodiments, the additive is an impact modifier.

In some embodiments, the composite of the invention is substantially recyclable. In some embodiments, the composite of the invention is at least 80%, at least 90%, at least 95%, at least 97%, at least 99% recyclable, wherein recyclability is determined and scored according to Cyclos HTP guidelines (e.g., DIN EN ISO 13430).

In some embodiments, the composite of the invention is a film. In some embodiments, the film according to embodiments of the invention may be laminated to a polymeric substrate forming a recyclable laminate film. Such a recyclable laminate may be used for forming recyclable packages or packaging materials.

In some embodiments, the solid composite is characterized by at least one improved mechanical property selected from: modulus, impact at notch, stress at brake, yield strain, tensile strength, elongation at break, impact resistance or any combination thereof, wherein improved is relative to a control (e.g., a composite or a multi-layered extrudate or laminate having the same polymeric composition and is devoid of the modified particle of the invention).

In some embodiments, the solid composite is characterized by at least one improved mechanical property, wherein improved comprises at least 10%, at least 50%, at least 100%, at least 200%, at least 500%, at least 1000%, compared to a control, including nay range between.

In some embodiments, the solid composite is characterized by an impact at notch improved by at least 10%, at least 50%, at least 100%, at least 200%, at least 500%, at least 1000%, including nay range between, as compared to a control.

In some embodiments, there is provided an article comprising the solid composite of the invention. In some embodiments, article is a film. In some embodiments, the article comprises the composite bound to a substrate. In some embodiments, article has any 3-dimensional shape. In some embodiments, article is a packaging article.

### Method

According to some embodiments, the present invention provides a method of forming the solid composite of the invention, comprising: (a) providing a first polymer and optionally a second polymer under conditions suitable for melting, to obtain a melt; (b) mixing the melt with a sufficient amount of the modified particles of the invention, thereby forming a mixture; and (c) providing the mixture under conditions suitable for solidifying of the mixture (e.g. by cooling, or reducing the temperature of the mixture below the melting point), thereby forming the solid composite. In some embodiments, the solid composite is recyclable. In some embodiments, the method of the invention is for recycling of a polymer blend (e.g., a mixture or a multi-layered polymeric material) comprising a first polymer and a second polymer, wherein the first and second polymer are immiscible.

In some embodiments, the sufficient amount is so as to obtain a stable composite. In some embodiments, the sufficient amount is so as to obtain a stable mixture (e.g., homogenous mixture, devoid of phase separation). In some embodiments, the sufficient amount is between 0.01 and 10%, between 0.1% to 10% (w/w), 0.05% to 10% (w/w), 0.09% to 10% (w/w), 0.1% to 10% (w/w), 0.5% to 10% (w/w), 0.9% to 10% (w/w), 1% to 10% (w/w), 10% to 15% (w/w), 15% to 20% (w/w), 5% to 10% (w/w), 0.01% to 9% (w/w), 0.05% to 9% (w/w), 0.09% to 9% (w/w), 0.1% to 9% (w/w), 0.5% to 9% (w/w), 0.9% to 9% (w/w), 1% to 3% (w/w), 3% to 5% (w/w), 5% to 9% (w/w), 5% to 7% (w/w), 7% to 10% (w/w), 1% to 9% (w/w), 5% to 9% (w/w), 0.01% to 5% (w/w), 0.05% to 5% (w/w), 0.09% to 5% (w/w), 0.1% to 5% (w/w), 0.5% to 5% (w/w), 0.9% to 5% (w/w), or 1% to 5% (w/w), including any range therebetween.

In some embodiments, conditions suitable for melting comprise a temperature sufficient for melting of the first thermoplastic polymer and optionally of the second thermoplastic polymer. In some embodiments, conditions suitable for melting comprise a temperature of at least 10% less than the melting point of the first or of the second polymer.

In some embodiments, mixing comprises stirring, high shear mixing, ultrasonication, overhead stirring, homogenizing, or a combination thereof. In some embodiments, the steps a. and b. of the method are performed simultaneously, such as by extrusion.

In some embodiments, a w/w ratio between the first polymer and the second polymer within the melt is between 1:100 and 1:1, between 1:1 and 1:10, between 1:10 and 1:20, between 1:2 and 1:20, between 1:3 and 1:20, between 1:20 and 1:30, between 1:30 and 1:50, between 1:50 and 1:100, including any range or value therebetween.

### General

As used herein the term “about” refers to +10%.

The terms “comprise”, “comprising”, “includes”, “including”, “having” and their conjugates mean “including but not limited to”.

The term “consisting of” means “including and limited to”.

The term “consisting essentially of” means that the composition, method or structure may include additional ingredients (up to a concentration of 10%, of 5%, of 1%, of 0.1%, including any range between) steps and/or parts, but only if the additional ingredients, steps and/or parts do not materially alter the basic and novel characteristics of the claimed composition, method or structure. Thus the composition or the particle consisting essentially of one or more constituents, means that the concentration of the one or more constituents within the particle or the composition is between about 90 and about 99.9%, between about 90 and about 95%, between about 95 and about 99.9%, between about 95 and about 97%, between about 97 and about 99.9%, including any range between.

The term “at least partially” as used herein refers to at least 30%, at least 50%, at least 70%, at least 80%, at least 90%, including any range or value therebetween.

The term “substantially”, as used herein refers to at least 90%, at least 93%, at least 95%, at least 97%, at least 99%, at least 99.9% including any range or value therebetween.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the invention may include a plurality of “optional” features unless such features conflict.

As used herein, the singular form “a”, “an” and “the” include plural references unless the context clearly dictates otherwise. For example, the term “a compound” or “at least one compound” may include a plurality of compounds, including mixtures thereof.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

As used herein the term “method” refers to manners, means, techniques and procedures for accomplishing a given task including, but not limited to, those manners, means, techniques and procedures either known to, or readily developed from known manners, means, techniques and procedures by practitioners of the chemical, pharmacological, biological, biochemical and medical arts.

As used herein, the term “treating” includes abrogating, substantially inhibiting, slowing or reversing the progression of a condition, substantially ameliorating clinical or aesthetical symptoms of a condition or substantially preventing the appearance of clinical or aesthetical symptoms of a condition.

In one embodiment, the term “alkyl” comprises an aliphatic hydrocarbon including straight chain and branched chain groups. Preferably, the alkyl group has 21 to 100 carbon atoms, and more preferably 21-50 carbon atoms. Whenever a numerical range, e.g., “21-100”, is stated herein, it implies that the group, in this case the alkyl group, may contain 21 carbon atoms, 22 carbon atoms, 23 carbon atoms, etc., up to and including 100 carbon atoms.

In one embodiment, the term “long alkyl” comprises an alkyl having at least 20 carbon atoms in its main chain (the longest path of continuous covalently attached atoms). A short alkyl therefore has 20 or less main-chain carbons. In one embodiment, an alkyl can be substituted or unsubstituted. In one embodiment, the term “alkyl”, as used herein, also encompasses saturated or unsaturated hydrocarbon, hence this term further encompasses alkenyl and alkynyl.

In one embodiment, the term “alkenyl” describes an unsaturated alkyl, as defined herein, having at least two carbon atoms and at least one carbon-carbon double bond. The alkenyl may be substituted or unsubstituted by one or more substituents, as described hereinabove. In one embodiment, the term “alkynyl”, as defined herein, is an unsaturated alkyl having at least two carbon atoms and at least one carbon-carbon triple bond. The alkynyl may be substituted or unsubstituted by one or more substituents.

In one embodiment, the term “unsaturated” describes a compound containing one or more unsaturated bond(s). In some embodiments, an unsaturated bond refers to a double bond, and/or to a triple bond.

In one embodiment, the term “cycloalkyl” describes an all-carbon monocyclic or fused ring (i.e., rings which share an adjacent pair of carbon atoms) group where one or more of the rings does not have a completely conjugated pi-electron system. The cycloalkyl group may be substituted or unsubstituted.

In one embodiment, the term “aryl” describes an all-carbon monocyclic or fused-ring polycyclic (i.e., rings which share adjacent pairs of carbon atoms) groups having a completely conjugated pi-electron system. In one embodiment, an aryl group may be substituted or unsubstituted.

In one embodiment, the term alkoxy” describes both an —O-alkyl and an —O-cycloalkyl group. In one embodiment, the term “aryloxy” describes an —O-aryl. In one embodiment, the term alkyl, cycloalkyl and aryl groups in the general formulas herein may be substituted by one or more substituents, whereby each substituent group can independently be, for example, halide, alkyl, alkoxy, cycloalkyl, alkoxy, nitro, amine, hydroxyl, thiol, thioalkoxy, thiohydroxy, carboxy, amide, aryl and aryloxy, depending on the substituted group and its position in the molecule.

In one embodiment, “halide”, “halogen” or “halo” describes fluorine, chlorine, bromine or iodine. In one embodiment, “haloalkyl” describes an alkyl group as defined herein, further substituted by one or more halide(s). In one embodiment, “haloalkoxy” describes an alkoxy group as defined herein, further substituted by one or more halide(s). In one embodiment, the term “hydroxyl” or “hydroxy” describes a —OH group. In one embodiment, the term “thiohydroxy” or “thiol” describes a —SH group. In one embodiment, the term “thioalkoxy” describes both an —S-alkyl group, and a —S-cycloalkyl group. In one embodiment, the term “thioaryloxy” describes both an —S-aryl and a —S-heteroaryl group. In one embodiment, the term “amine” describes a —NR′R″ group, with R′ and R″. In one embodiment, the term “heteroaryl” describes a monocyclic or fused ring (i.e., rings which share an adjacent pair of atoms) group having in the ring(s) one or more atoms, such as, for example, nitrogen, oxygen and sulfur and, in addition, having a completely conjugated pi-electron system. Examples, without limitation, of heteroaryl groups include pyrrole, furane, thiophene, imidazole, oxazole, thiazole, pyrazole, pyridine, pyrimidine, quinoline, isoquinoline and purine.

In one embodiment, the term “heteroalylcyclic” or “heterocyclyl” describes a monocyclic or fused ring group having in the ring(s) one or more atoms such as nitrogen, oxygen and sulfur. The rings may also have one or more double bonds. In one embodiment, the rings do not have a completely conjugated pi-electron system. Representative examples are piperidine, piperazine, tetrahydrofuran, tetrahydropyran, morpholino and the like.

In one embodiment, the term “carboxy” or “carboxylate” describes a —C(═O)—OR′ group, where R′ is hydrogen, alkyl, cycloalkyl, alkenyl, aryl, heteroaryl(bonded through a ring carbon) or heteroalylcyclic (bonded through a ring carbon).

In one embodiment, the term “carbonyl” describes a —C(═O)—R′ group, where R′ is as defined hereinabove. In one embodiment, the above-terms also encompass thio-derivatives thereof (thiocarboxy and thiocarbonyl).

In one embodiment, the term “thiocarbonyl” describes a —C(═S)—R′ group, where R′ is as defined hereinabove. In one embodiment, the term “thiocarboxy” group describes a —C(═S)—OR′ group, where R′ is as defined herein. In one embodiment, the term sulfinyl” group describes an —S(═O)—R′ group, where R′ is as defined herein. In one embodiment, the term sulfonyl” or “sulfonate” group describes an —S(═O)2-R′ group, where R′ is as defined herein. In one embodiment, the term “carbamyl” or “carbamate” group describes an —OC(═O)—NR′R″ group, where R′ is as defined herein and R″ is as defined for R′.

In one embodiment, the term “nitro” group refers to a —NO2 group. In one embodiment, the term “cyano” or “nitrile” group refers to a —C═″ refers to a —N3 group. In one embodiment, the term “sulfonamide” refers to a —S(═O)2—NR′R″ group, with R′ and R″ as defined herein.” refers to a —N3 group. In one embodiment, the term “sulfonamide” refers to a —S(═O)2—NR′R″ group, with R′ and R″ as defined herein.

In one embodiment, the term “phosphonyl” or “phosphonate” describes an —O—P(═O)(OR′)2 group, with R′ as defined hereinabove. In one embodiment, the term “phosphinyl” describes a —PR′R″ group, with R′ and R″ as defined hereinabove.

In one embodiment, the term “alkaryl” describes an alkyl, as defined herein, which substituted by an aryl or a heteroaryl, as described herein. In one embodiment, alkaryl is benzyl.

In one embodiment, the term “heteroaryl” describes a monocyclic or fused ring (i.e., rings which share an adjacent pair of atoms) group having in the ring(s) one or more atoms, such as, for example, nitrogen, oxygen and sulfur and, in addition, having a completely conjugated pi-electron system. Examples, without limitation, of heteroaryl groups include pyrrole, furane, thiophene, imidazole, oxazole, thiazole, pyrazole, pyridine, pyrimidine, quinoline, isoquinoline and purine. The heteroaryl group may be substituted or unsubstituted by one or more substituents, as described hereinabove. Representative examples are thiadiazol, pyridine, pyrrole, oxazole, indole, purine and the like.

In one embodiment, the terms “halo” and “halide”, which are referred to herein interchangeably, describe an atom of a halogen, that is fluorine, chlorine, bromine or iodine, also referred to herein as fluoride, chloride, bromide and iodide. In one embodiment, the term “haloalkyl” describes an alkyl group as defined above, further substituted by one or more halide(s).

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Various embodiments and aspects of the present invention as delineated hereinabove and as claimed in the claims section below find experimental support in the following examples.

### EXAMPLES

Non-limiting synthetic procedures for the preparation of exemplary modified particles are as follows.

### Procedure A:

1 g Silica NPs was dispersed in 40 mL of ethanol by mechanical mixing. After ten minutes, 0.5 g, 0.45 ml of benzoyloxy propyl trimethoxysilane and 0.5 g, 0.57 ml of dodecyltriethoxysilane were added to the solution. The reaction was performed at ambient temperature for 45 min followed by vigorous stirring (800 rpm). The multi-functional silica particles were collected by four cycles of centrifugation followed by ethanol rinsing. The NPs were then dried in a vacuum oven at 35° C. for ca. 3 hours.

### Procedure B:

1 g Silica NPs were dispersed in 40 mL of ethanol by mechanical mixing. After ten minutes, 0.56 ml of Dodecyltriethoxysilane (DTES) and 0.50 ml of S-(Octanoyl) mercaptopropyltriethoxysilane were added to the solution. The reaction was performed at ambient temperature for 45 min followed by vigorous stirring (800 rpm). The multi-functional silica particles were collected by four cycles of centrifugation followed by ethanol rinsing. The NPs were then dried in a vacuum oven at 35° C. for ca. 3 hours.

The inventors successfully implemented the above-described exemplary particles for compounding (forming a stable blend) of two immiscible polymers, including inter alia polymer blends based on PE/PP, PE/PE, PVE/PE, PE/rubber (e.g., vulcanized rubber), PP/rubber (e.g., vulcanized rubber).

The composites comprising the modified particles and the first and/or the second polymer, as described herein, can be manufactured by extrusion a mixture comprising a sufficient amount of the modified particles and the first and/or the second polymer. Various w/w concentrations of the modified particles within the polymer or polymer blends have been successfully incorporated, ranging between 1 and 3% have been utilized for the preparation of stable composites described herein (e.g., via extrusion).

Furthermore, the inventors presume that the composites will exhibit improved mechanical properties, as compared to co-extruded layered controls (being devoid of the modified particles of the invention).

Additionally, physical and mechanical properties (e.g., modulus, impact at notch, stress at brake, yield strain, tensile strength, elongation at break, impact resistance or any combination thereof) and the recyclability of the composites can be tested via conventional methods, which are well-known in the art.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

1. A modified particle comprising an inorganic nanoparticle covalently bound to a plurality of first moieties and to a plurality of second moieties, wherein:
the first moiety comprises one or more residue selected from an alkyl, and alkenyl or both; and
the second moiety comprises one or more residue selected from the group comprising aromatic ester, a benzoyl ester, an alkyl ester, aromatic thioester, alkyl thioester, haloalkyl, mercaptoalkyl, disulphide, trisulphide, tetrasulphide, mercapto, ether, thioether, amine, amide, amidine, guanidine, carbamate, sulfoxide, sulfone, propylene oxide, or any combination thereof.

2. The modified particle of claim 1, wherein a molar ratio between the plurality of first moieties and the plurality of second moieties within the modified particle is between 2:1 and 1:2.

3. The modified particle of claim 1, wherein the one or more residue of the first moiety and the one or more residue of the second moiety are each covalently bound to an outer surface of said inorganic nanoparticle via a functional group selected from silyl, siloxane, carboxy, ester, ether, carbonyl, phosphate, phosphine, alkyl, including any combination thereof; wherein said inorganic nanoparticle is a solid nanoparticle, comprising a metal oxide, or a metalloid oxide; and wherein the inorganic nanoparticle is characterized by an average particle size of between 1 and 100 nm; optionally wherein the inorganic nanoparticle is or comprises a silica nanoparticle.

4. The modified particle of claim 1, wherein the one or more residue of the first moiety comprises an C8-C20 alkyl.

5. (canceled)

6. The particle of claim 1, wherein the one or more residue of the second moiety comprises any of X—C(═O)-Het-(C₁₋₁₀)₁₋₂, C₁₋₁₀—C(═O)—S—C₁₋₁₀, and a C8-C20 haloalkyl, wherein X represents an aromatic or a heteroaromatic ring, Het represents a heteroatom selected from —O—, —S—, and —NH—; and wherein the functional group is siloxane.

7. The modified particle of claim 1, wherein the one or more residue of the second moiety comprises benzoyloxy propyl, or S-(Octanoyl) mercaptopropyl, or any combination thereof; optionally wherein the plurality of first moieties and the plurality of second moieties are assembled in a form of a shell on the outer surface; and wherein the plurality of first moieties and the plurality of second moieties are substantially uniformly distributed within said shell.

8. (canceled)

9. (canceled)

10. (canceled)

11. The modified particle of claim 1, wherein the particle is dispersible within a polymeric melt comprising at least two immiscible polymers; wherein said polymeric melt comprises a first polymer and a second polymer wherein a w/w ratio between the first polymer and the second polymer is between 1:100 and 100:1, including any range between; and wherein said dispersible is up to a concertation of about 10% (w/w) of the particles within the polymeric melt.

12. (canceled)

13. The modified particle of claim 11, wherein said first polymer is or comprises polyethylene (PE) and the second polymer comprises one or more from a polyolefin which is not PE, a polyvinylchloride, polystyrene, rubber, a polyester polyurethane, including any copolymer, or any combination thereof; optionally wherein said a polyolefin which is not PE comprises polypropylene, poly(l-butene), poly(l-hexene), poly(l-octene), polyisobutylene, including any mixture or any copolymer thereof, and wherein said polyester is PET.

14. A solid composite comprising a plurality of the modified particles of claim 1 distributed within a polymeric matrix, wherein the polymeric matrix comprises at least one first polymer and at least one second polymer; wherein the first polymer and the second polymer are immiscible polymers; and wherein a w/w concentration of the modified particles within the polymeric matrix is between 0.01 and 10%, including any range between.

15. The solid composite of claim 14, wherein said first polymer is or comprises polyethylene (PE) and the second polymer comprises one or more from a polyolefin which is not PE, a polyvinylchloride, a polystyrene, a rubber, a polyester, a polyurethane, including any copolymer, or any combination thereof;

16. The solid composite of claim 14, wherein a w/w ratio of said first polymer to said second polymer within the polymeric matrix is between 1:1 and 1:100; and wherein a w/w ratio of said first polymer to said second polymer within the polymeric matrix is between 1:3 and 1:20; wherein the first polymer and the second polymer are homogenously distributed within the solid composite; and wherein the modified particles are substantially uniformly distributed within the polymeric matrix.

17. (canceled)

18. (canceled)

19. The solid composite of claim 15, wherein the polyolefin which is not PE comprises polypropylene, poly(l-butene), poly(l-hexene), poly(l-octene), polyisobutylene, including any mixture or any copolymer thereof, and wherein the polyester comprises PET or a copolymer thereof.

20. The solid composite of claim 14, wherein the solid composite is characterized by at least one improved mechanical property selected from: modulus, impact at notch, stress at brake, yield strain, tensile strength, elongation at break, impact resistance or any combination thereof.

21. The solid composite of claim 14, wherein the solid composite is shapeable by hot melt processing; and wherein the first polymer and the second polymer are thermoplastic, or meltable.

22. (canceled)

23. A method for forming the solid composite of claim 14, comprising:
a. providing the first polymer and optionally the second polymer under conditions suitable for melting, to obtain a melt;
b. mixing the melt with a sufficient amount of the modified particles of claim 1, thereby forming a mixture; and
c. providing said mixture under conditions suitable for solidifying of the mixture, thereby forming the solid composite.

24. The method of claim 23, wherein conditions suitable for melting comprise a temperature sufficient for melting of the first thermoplastic polymer and optionally of the second thermoplastic polymer.

25. The method of claim 23, wherein said mixing comprises stirring, high shear mixing, ultrasonication, overhead stirring, homogenizing, or a combination thereof.

26. The method of claim 23, wherein the steps a. and b. are performed simultaneously, such as by extrusion.

27. The method of claim 23, wherein a w/w concentration of the particles within the melt is between 0.1 and 10%.

28. The method of claim 23, wherein a w/w ratio of said first polymer to said second polymer within the melt is between 1:100 and 1:1, optionally between 1:20 and 1:3.
